(19) United States
(12) Patent Application Publication
(10) Pub. No.: US 2021/0099782 A1
(43) Pub. Date: Apr. 1, 2021

(54) STATE CLASSIFICATION FOR AUDIO ACCESSORIES, AND RELATED SYSTEMS AND METHODS

(71) Applicant: Apple Inc., Cupertino, CA (US)

(72) Inventors: Sorin V. Dusan, San Jose, CA (US); Dubravko Biruski, Cupertino, CA (US); Sungyub D. Yoo, Dublin, CA (US)

(21) Appl. No.: 16/998,135

(22) Filed: Aug. 20, 2020

Related U.S. Application Data
(60) Provisional application No. 62/907,397, filed on Sep. 27, 2019.

(51) Int. Cl. H04R 1/10; H04R 3/00; H04R 1/28

(52) U.S. Cl. CPC H04R 1/105; H04R 3/00; H04R 1/1016; H04R 1/1075; H04R 1/2896

(57) ABSTRACT

An earphone has a housing and a corresponding user-contact surface configured to urge against a user's anatomy. The housing defines an acoustic chamber and an acoustic port opening from the acoustic chamber. The user-contact surface is complementarily configured relative to the user's anatomy. When the earphone is donned, the user-contact surface forms an acoustic seal between the user-contact surface and the user's anatomy, acoustically coupling the acoustic chamber with the user's ear canal. An acoustic driver is positioned in the housing and acoustically coupled with the acoustic chamber. A microphone transducer acoustically couples with the acoustic port. A processing component is configured to detect a presence or an absence of anti-resonance in a spectral envelope observed by the microphone transducer.

### FIELD

This application and related subject matter (collectively referred to as the “disclosure”) generally concern state classification for audio accessories, such as, for example, earphones, as well as related systems and methods. More particularly, but not exclusively, this disclosure pertains to wear state of an earphone.

### BACKGROUND INFORMATION

Media devices can communicate an audio signal to one or more audio accessories during audio playback. For example, a media device can communicate audio to one or more in-ear, on-ear, or over-the-ear earphones to be worn by a user during playback. Perceived sound quality and other measures of performance for such an earphone can vary in correspondence with how well the earphone fits a particular user's ear or head anatomy. For example, perceived sound quality can deteriorate if an in-ear earphone is not well-seated in a user's ear canal, or if an on-ear or an over-the-ear earphone allows sound to leak past an ear-cup boundary. Similarly, a well-fitting earphone may be subjectively more comfortable to a user than an ill-fitting earphone.

“Fit,” in general, can correspond to one or more of, for example, a position, an orientation, and a shape of an earphone relative to a user's anatomy. For example, an ear tip for an in-ear earphone that provides a substantially uniform pressure to a surface of a wearer's ear canal can provide perceptually better sound and subjective comfort compared to an ear tip that impinges on one region of a wearer's ear canal while barely urging against or contacting another region.

### SUMMARY

According to an aspect, an earphone can determine whether a user is wearing the earphone, as by assessing a frequency response observed by the earphone.

According to another aspect, an earphone includes a housing and a corresponding user-contact surface configured to urge against a user's anatomy. The housing defines an acoustic chamber and an acoustic port opening from the acoustic chamber. The user-contact surface is so complementarily configured relative to the user's anatomy as to form an acoustic seal between the user-contact surface and the user's anatomy, acoustically coupling the acoustic chamber with the user's ear canal, when the earphone is donned. The earphone also has an acoustic driver positioned in the housing. The acoustic driver acoustically couples with the acoustic chamber. As well, a microphone transducer acoustically couples with the acoustic port. A processing component is configured to detect anti-resonance in sound observed by the microphone transducer across a selected spectral envelope spanning or above the upper threshold of human hearing.

The processing component can be configured to affect operation of the earphone responsive to detection of anti-resonance in the spectral envelope.

The processing component can be configured to cause the acoustic driver to emit sound in the spectral envelope and to cause the microphone transducer to observe sound in the spectral envelope.

The spectral envelope can have a lower frequency threshold of about 20 kHz and an upper frequency threshold of about 24 kHz.

The processing component can be configured to assess a frequency response across the spectral envelope and to identify a presence of a notch in the frequency response.

The processing component can be configured to classify the earphone as being donned when anti-resonance is detected. The processing component can also be configured to classify a quality of the acoustic seal between the user-contact surface and the user's anatomy based at least in part on the frequency response across the spectral envelope.

The earphone can also include an ear-tip defining the user-contact surface. The user's anatomy can be an inner surface of the user's ear canal, and the user-contact surface can be configured to urge against the inner surface of the wearer's ear canal and form the acoustic seal.

According to another aspect, an earphone includes a housing, a loudspeaker transducer and a microphone transducer positioned in the housing. The earphone also has a processor and a memory containing instructions that, when executed by the processor, cause the earphone to assess sound observed by the microphone within a frequency band having a lower threshold of about 20 kHz and an upper threshold of about 24 kHz. Based on the assessment, the instructions, when executed, can also cause the earphone to determine when the earphone is donned by a user.

The assessment of sound can include an assessment of a frequency response within the frequency band. The instructions, when executed by the processor, can further cause the earphone to identify a presence or an absence of anti-resonance within the frequency band from the assessment of the frequency response. The instructions, when executed by the processor, can also cause the earphone to classify a quality of fit between the earphone and a corresponding region of a user's anatomy.

The earphone can include an in-ear ear-tip defining a corresponding user-contact surface configured to urge against a wall of a user's ear canal and form an acoustic seal between the in-ear ear-tip and the user's ear canal. The housing can define an acoustic chamber and the in-ear ear-tip can define an acoustic port opening from the acoustic chamber. The acoustic port can be configured to acoustically couple the acoustic chamber with the user's ear canal when the in-ear ear-tip is inserted into the user's ear canal.

When the instructions are executed, the earphone can classify a quality of the acoustic seal between the in-ear ear-tip and the user's ear canal.

According to yet another aspect, methods for controlling operation of an earphone are described. For example, the earphone can house a microphone transducer and an acoustic driver. According to the method, sound is emitted across a spectral envelope with the acoustic driver. Sound observed by the microphone is assessed within the spectral envelope. The spectral envelope has a lower threshold of about 20 kHz and an upper threshold of about 24 kHz. When the earphone is donned by a user is determined based on the sound assessment.

The act of assessing sound within the spectral envelope can include determining a presence or an absence of anti-resonance within the spectral envelope.

A quality of fit between the earphone and a user's anatomy can be classified based on the sound assessment.

Operation of the earphone can be affected responsive to detection of anti-resonance in the spectral envelope.

The act of assessing sound within the spectral envelope can include assessing a frequency response across the spectral envelope.

Also disclosed are associated methods, as well as tangible, non-transitory computer-readable media including computer executable instructions that, when executed, cause a computing environment to implement one or more methods disclosed herein. Digital signal processors embodied in software, firmware, or hardware and being suitable for implementing such instructions also are disclosed.

The foregoing and other features and advantages will become more apparent from the following detailed description, which proceeds with reference to the accompanying drawings.

### BRIEF DESCRIPTION OF THE DRAWINGS

Referring to the drawings, wherein like numerals refer to like parts throughout the several views and this specification, aspects of presently disclosed principles are illustrated by way of example, and not by way of limitation.

FIG. 1 illustrates a media device and an associated audio accessory.

FIG. 2 schematically illustrates anatomy of a typical human ear.

FIG. 3 schematically illustrates an in-ear earphone positioned in the human ear shown in FIG. 2.

FIG. 4 schematically illustrates a cross-sectional view of an in-ear earphone, together with an ear-tip configured to acoustically seal with a user's ear canal.

FIG. 5 schematically illustrates an in-ear earphone seated in a user's ear canal, occluding the ear-canal and associated anatomical cavities.

FIG. 6 schematically illustrates a frequency response of the occluded ear-canal, as observed by a microphone in the earphone shown in FIG. 5.

FIG. 7 depicts several frequency responses observed by a working embodiment of an earphone when being worn and being not worn by three different users within a sample population.

FIG. 8 schematically illustrates a spectrogram comparing a frequency response when an earphone is inserted in a wearer's ear (donned) to a frequency response when the earphone is extracted.

FIG. 9 schematically illustrates a process for operating an audio accessory, e.g., according to whether the accessory classifies itself as being worn or not worn by a user.

FIG. 10 illustrates a block diagram showing aspects of an audio appliance.

FIG. 11 illustrates a block diagram showing aspects of a computing environment.

### DETAILED DESCRIPTION

The following describes various principles related to audio accessories configured to determine whether a user has doffed or donned the respective accessory. As one illustrative example, an earphone can include a processing component configured to classify a status of the earphone as being worn (donned) or not worn (doffed). The classification can be based on whether an observed frequency response to sound emitted by the earphone exhibits anti-resonance within a frequency band spanning or above the upper fringe of human hearing.

Descriptions herein of specific appliance, accessory, or system configurations, and specific combinations of method acts, are but particular examples of contemplated appliances, accessories, systems, and methods chosen as being convenient illustrative examples of disclosed principles. One or more of the disclosed principles can be incorporated in various other appliances, accessories, systems, and methods to achieve any of a variety of corresponding, desired characteristics. Thus, a person of ordinary skill in the art, following a review of this disclosure, will appreciate that appliances, accessories, systems, and methods having attributes that are different from those specific examples discussed herein can embody one or more presently disclosed principles, and can be used in applications not described herein in detail. Such alternative embodiments also fall within the scope of this disclosure.

### I. Overview

A frequency response of an occluded, human ear canal may exhibit an anti-resonance trough, or notch, within a frequency band spanning or above the upper threshold frequency of human hearing. Common anatomical features within a human ear occluded by an earphone can define a side cavity acoustically coupled with, for example, an ear canal, a middle ear, a Eustachian tube, or a combination thereof. Like a side-branch resonator can absorb acoustic energy from an acoustic chamber, such anatomical side cavities can resonate at certain frequencies and absorb substantial acoustic energy from anatomical features at those frequencies.

By detecting an anti-resonance in a specific frequency range, an earphone can discern whether, and in some instances to what extent, a user has properly donned the earphone. Such anti-resonance, when observed or detected by an earphone, can indicate that a user is wearing the earphone. For example, anti-resonance troughs, or notches, were consistently observed in the frequency response of each occluded, human ear canal across a sample population of users. Although the frequency at which anti-resonance occurred for each ear canal, e.g., the frequency at which the reduction in energy was concentrated, varied across the population, the frequency consistently fell within a range spanning or above the upper threshold of human hearing. More particularly, anti-resonance occurred within a bandwidth from about 20 kHz to about 24 kHz, such as, for example, between about 16 kHz and about 26 kHz, e.g., between about 18 kHz and about 25 kHz.

An earphone configured to identify a presence or an absence of such anti-resonance can determine a corresponding wear state of the earphone. For example, an earphone that identifies a presence of anti-resonance can infer that the earphone is being worn by a user. Alternatively, an earphone that identifies an absence of anti-resonance can infer that the earphone is not being worn by a user.

Such an earphone can house a loudspeaker transducer or other acoustic driver, as well as a microphone transducer. A processing unit associated with the earphone can assess sound observed by the microphone to determine whether anti-resonance may be present in the observed sound, e.g., within a defined spectral envelope. Based on the assessment, the processing unit can classify a status of the earphone, e.g., as being worn or as being not worn.

Stated differently, the classification can correspond with a frequency response, as observed by the microphone, to an output sound emitted by the driver. In this example, the processing unit can discern between or among various local environments according to an observed frequency response of the environment. For example, an ear canal occluded by the earphone can exhibit anti-resonance within a given bandwidth, e.g., from about 20 kHz to about 24 kHz. As noted above, an earphone can occlude an ear canal, defining a resonant chamber, e.g., vis-à-vis the ear canal. As well, an internal volume of the earphone can define a side cavity, or a portion thereof, relative to the resonant chamber defined by the ear canal, which together with the occluded ear canal can give rise to anti-resonance at a frequency between about 20 kHz and about 24 kHz. Nonetheless, when the earphone is removed from the occluding relation to the ear canal, the earphone is no longer exposed to a combination resonant chamber (ear canal) and side cavity (internal earphone chamber). Consequently, a doffed earphone neither induces nor observes anti-resonance in a side cavity.

Anti-resonance can be identified by a substantial drop in energy content concentrated at a specific frequency within that bandwidth. By contrast, an observed frequency response across the bandwidth may lack an indication of anti-resonance when the earphone is not being worn, or if the earphone is insufficiently or improperly seated against a corresponding region of a user's head or ear canal, or otherwise does not occlude the ear canal. For example, standing waves can occur in the occluded ear canal, and anti-resonance can occur at a frequency corresponding to a length of the ear canal extending away from the earphone. For example, a 25 mm ear canal occluded by an in-ear earphone may have an effective length past the earphone of between about 15 mm and about 17 mm. Consequently, standing waves can occur in the shortened ear canal at a frequency corresponding to the length of the shortened ear canal. In this example, the standing waves can occur at a frequency between about 10 kHz and about 11.5 kHz, resulting in an anti-resonance node observed at the microphone. Such an anti-resonance can be used to detect a wear state. Nonetheless, anti-resonance occurring at such a low frequency (e.g., in the audible range) may be undesirable as it could degrade a user's listening experience. Some earphones, e.g., earphone 40, can have a controlled leak, as to tune a frequency response of the earphone when donned. Such a controlled leak may shift or strengthen or weaken an anti-resonance peak from the specific frequencies and amplitudes used herein to describe selected principles, but the principles remain intact.

The processing unit can classify the earphone's status based on an assessment of the frequency response in the selected bandwidth. The assessment can include determining whether the observed sound exhibits a characteristic indicative of anti-resonance in a user's ear canal. For example, such a characteristic can include a notch, or a trough, in sound level (e.g., energy content) concentrated at a specific frequency with the selected bandwidth, e.g., from about 20 kHz to about 24 kHz. Alternatively, the presence or absence of anti-resonance can be inferred according to polynomial coefficients used to model a frequency response over the spectral envelope, as will be described further below.

### II. Media Devices

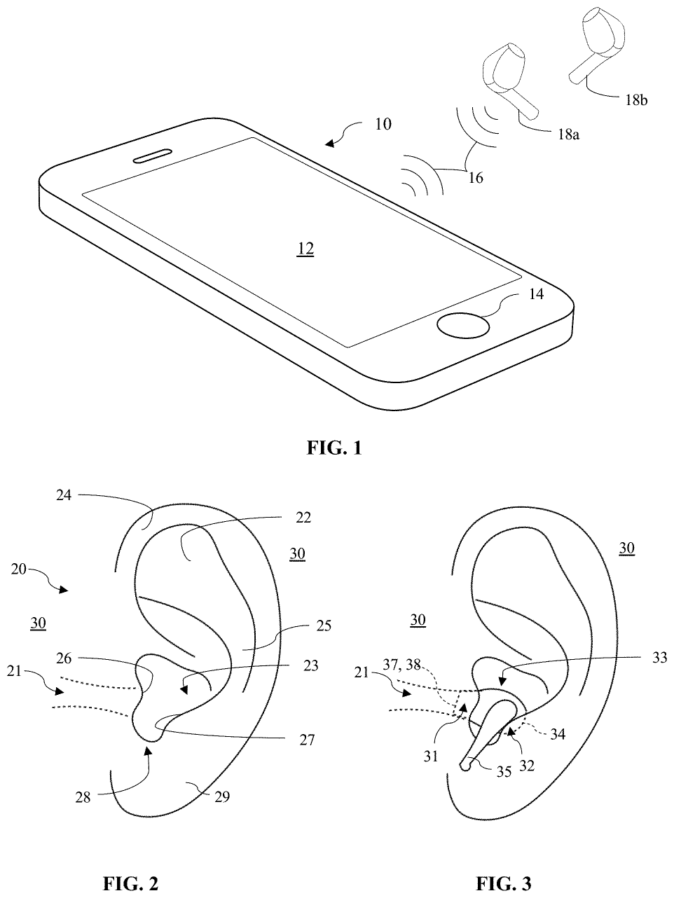

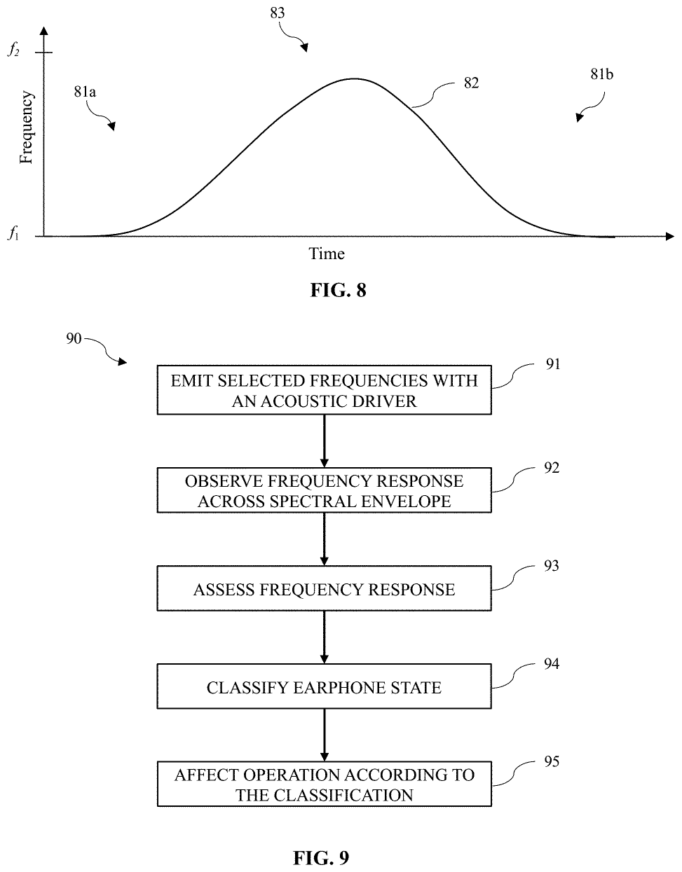

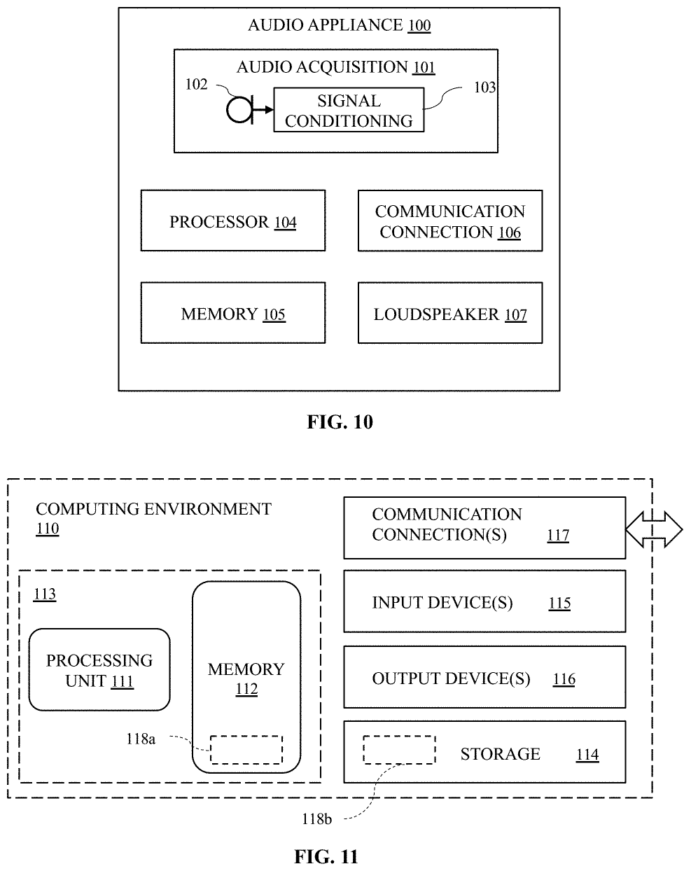

FIG. 1 shows a portable media device 10 suitable for use with a variety of accessory devices. The portable media device 10 can include a touch sensitive display 12 configured to provide a touch sensitive user interface for controlling the portable media device 10 and in some embodiments any accessories to which the portable media device 10 is electrically or wirelessly coupled. For example, the media device 10 can include a mechanical button 14, a tactile/haptic button, or variations thereof, or any other suitable ways for navigating on the device. The portable media device 10 can also include a communication connection, e.g., one or more hard-wired input/output (I/O) ports that can include a digital I/O port and/or an analog I/O port, or a wireless communication connection as generally described below in connection with FIGS. 9 and 10.

An accessory device can take the form of an audio device that includes two separate earphones 18a and 18b. Each of the earphones 18a and 18b can include wireless receivers, transmitters or transceivers capable of establishing a wireless link 16 with the portable media device 10 and/or with each other. One or both earphones 18a and 18b can also include a processing unit and a memory. The memory can store executable instructions that, when executed by the processor, cause the respective one or both earphones to carry out a method as described herein, or an associated method act, with other method acts carried out by, e.g., the media device or another network-connected appliance.

Alternatively, and not shown in FIG. 1, the accessory device can take the form of a wired or tethered audio device that includes separate earphones. Such wired earphones can be electrically coupled to each other and/or to a connector plug by a number of wires. The connector plug can matingly engage with one or more of the I/O ports and establish a communication link over the wire and between the media device and the accessory. In some wired embodiments, power and/or selected communications can be carried by the one or more wires and selected communications can be carried wirelessly.

Although FIG. 1 depicts the accessory device as being in-ear earphones, an accessory device can be configured as an over-the-ear earphone or an on-the-ear earphone.

### III. In-Ear Earphones

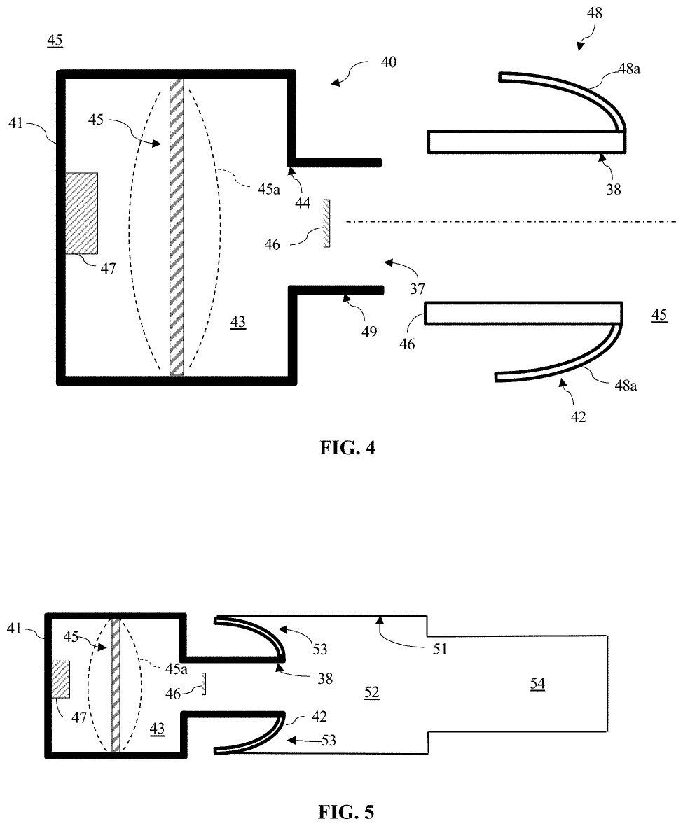

FIG. 2 schematically depicts anatomy of a human ear and FIG. 3 schematically depicts an in-ear earphone inserted in the ear. As shown in FIG. 4, the earphone can have a housing 40 and an associated, removable ear-tip 48. Although the illustrated ear-tip 48 is shown as being removable from the housing 40, persons skilled in the art will appreciate that other ear-tip configurations are integral with the housing or otherwise designed not to be removable from the housing 40 by a user. Whether intended to be removable or irremovable, earphone ear-tips can be configured to seat within a wearer's ear canal 41 (FIGS. 2 and 3) when the earphone is worn by a user.

FIG. 3 shows the earphone housing 40 positioned within an ear 20 of a user during use. More particularly, but not exclusively, the ear-tip 48 is positioned in an occluding orientation in the ear canal 21 in FIG. 3. As depicted among FIGS. 2, 3 and 4, an earphone housing 40 can define a major medial surface that faces the surface of the user's concha cavum 23 when the ear-tip 48 is seated in a user's ear canal 21.

As indicated in FIG. 3, an ear-tip 48 can be configured to urge against a surface of a wearer's ear canal 21, occluding the ear canal when the ear-tip is properly inserted into the ear canal. Because the ear-tip portion of an earphone sits at least partially within the ear canal of a user during use, an external surface of the ear tip generally contacts various portions of the ear to help keep it positioned within the ear of a user.

For example, when properly positioned in a user's ear 20, the illustrated earphone housing 40 can rest in the user's concha cavum 33 between the user's tragus 26 and anti-tragus 27, as in FIG. 3. An external surface of the housing, e.g., the major medial surface, can be complementarily contoured relative to, for example, the user's concha cavum 23 (or other anatomy) to provide a contact region 33 (FIG. 3) between the contoured external surface and the user's skin when the earphone is properly positioned.

Those of ordinary skill in the art will understand and appreciate that, although the complementarily contoured external surface of the earphone housing 40 is described in relation to the concha cavum 23, that region (or other external regions) of an earphone housing 40 can be complementarily contoured relative to another region of a human ear 20. For example, the housing 40 defines a major bottom surface 34 that is shown generally resting against the region of the user's ear between the anti-tragus 27 and the concha cavum 23 to define a contact region 32. Still other contact regions are possible.

For example, the housing 40 can define a major lateral surface positioned opposite the major medial surface defining the contact surface 33. A post 35 can extend from the major lateral surface. The post 35 can include a microphone transducer, a processing component, and/or other component(s) such as a battery. Alternatively, in context of a wired earphone, one or more wires can extend from the post 35. When the earphone is properly donned, as in FIG. 3, the post 35 extends generally parallel to a plane defined by the user's earlobe 29 at a position laterally outward of a gap 28 between the user's tragus 26 and anti-tragus 27.

The illustrated earphone housing 40 also defines an acoustic port 37. The port 37 provides an acoustic pathway from an interior region of the housing 40 to an exterior region, e.g., region 45. As shown in FIG. 4, the housing 40 can also define a boss or other protrusion 49 to which the removable ear-tip 48 can removably attach. The housing 40 can be formed of any material or combination of materials suitable for earphones. For example, some housings are formed of acrylonitrile butadiene styrene (ABS). Other representative materials include polycarbonates, acrylics, methacrylates, epoxies, and the like.

A complementarily configured ear-tip 48 can define a connector 46 configured to matingly engage the connector 49. The ear-tip 48 can be removable and replaceable by a user so that various different compliant ear-top sizes and shapes can be used to customize the overall size and shape of the earphone 40 to correspond to the ear of any user. As shown in FIG. 4, the ear-tip 48 can define an aperture 38 extending through the ear-tip to align with the acoustic port 37 when the connector 46 and the connector 49 are matingly engaged with each other.

In FIG. 4, the port 37 opens through the protrusion 49 defined by the housing and acoustically couples the aperture 38 in the ear-tip 48 to the acoustic chamber 43 in the housing. As well, the aperture 38 acoustically couples the port 37 to the exterior region 45. As shown in FIGS. 3 and 4, the port 37 and aperture 38 aligns with and opens to the user's ear canal 21 when the earphone is properly donned. A mesh, screen, film, or other protective barrier (not shown) can extend across the port 37, the aperture 38, or both, to inhibit or prevent intrusion of debris into the interior of the housing.

In FIG. 4, the illustrated ear-tip 48 includes a compliant lobe 42 extending radially outward of the connector 46. The compliant lobe 42 can urge outwardly against the wall of the wearer's ear canal 21 and resiliently deform when the ear-tip is inserted into a wearer's ear canal. As well, the lobe 42 can conform to a contour of the wearer's ear canal. By conforming to the surface contour of the ear-canal, the deformable region can establish an acoustic seal 31 (FIG. 3) between the walls of the ear canal 21 and the ear tip 48, effectively expanding the volume of the acoustic chamber 43 within the earphone housing 40 to include a volume of the ear canal 21, altering a perceived sound quality of the earphone. For example, an effective increase in volume for an acoustic chamber can increase a bass-response of the chamber, making sound emitted by the earphone perceptually deeper and richer sounding. However, perceived sound quality emitted by an in-ear earphone can deteriorate when the ear tip is not well seated against the wearer's ear canal, as can occur when the earphone is misaligned with the ear or is mis-sized with respect to the wearer's ear canal.

The compliant lobe 42 can conform to a number of different ear shapes and sizes. The compliant lobe 42 can be made from any of a number of different types of materials including, for example, open-cell foam, thermoplastic elastomers (TPE) and the like. In some embodiments, a material used to construct compliant lobe 42 can be configured to provide more force upon the ear of a user resulting in a more robust fit within the ear of a user. In an aspect, the lobe 42 is formed of silicone and can provide an intermediate structure forming a sealing engagement between the walls of the user's ear canal 31 and the housing 20 over the contact region 41. The sealing engagement can enhance perceived sound quality, as by passively attenuating external noise and inhibiting a loss of sound power from the wearer's ear canal. In general, a compliant member 42 can be formed of, for example, polymers of silicone, latex, and the like.

### IV. On-Ear and Over-the-Ear Earphones

Some earphones are designed to be worn on or over a user's ears, as opposed to being inserted into the user's ear canal as described above in relation to FIGS. 3 and 4. A headset can have a headband that supports one or more earphones in relation to a user's head, e.g., ears. Often, such headsets include a pair of earphones, and the headband supports and separates the earphones from each other. An earphone designed to be worn on or over a user's ear can operatively couple with a media device using a wire or can be wireless, as with the accessory device in FIG. 1.

Each earphone, in turn, can have one or more respective loudspeaker transducers or other acoustic drivers positioned within a housing. Generally speaking, a housing can define an acoustic enclosure for the driver(s), providing the respective earphone with selected acoustic characteristics (e.g., a selected response at various audible frequencies, a degree of acceptable harmonic distortion, etc.). An on-ear or over-the-ear earphone can also have ear pads or cushions. The ear cushions can make wearing the headset comfortable and can provide a suitable acoustic seal with the user's outer ear or a surrounding region of the wearer's head. With such an acoustic seal, an on-ear or an over-the-ear earphone can effectively occlude a wearer's ear canal, incorporating the ear canal as part of an acoustic chamber defined by the earphone. Similar anti-resonances can occur for on-ear or over-the-ear headphones when worn by users on their heads, but the corresponding frequencies may be lower than those identified herein for in-ear earphones.

A circumaural earphone, commonly referred to in the art as an “over-the-ear headphone,” has an ear pad configured to surround a user's outer ear and to urge directly against the user's head at a position outwardly of the ear. By contrast, a supraaural headphone, commonly referred to in the art as an “on-ear earphone”, has an ear pad that rests on the wearer's outer ear.

### V. Earphone State Detection

As noted above, an earphone can listen for an indication of anti-resonance in a user's ear canal and, based on that observation, can determine whether a user has properly donned the earphone. FIG. 4 schematically illustrates features of an earphone 40 configured to determine whether the earphone has been doffed or donned.

As shown schematically in FIG. 5, the user-contact surface 42 can be complementarily configured relative to the user's anatomy 51 as to form an acoustic seal between the user-contact surface and the user's anatomy, acoustically coupling the acoustic chamber 43 with the user's ear canal 52 when the earphone is donned. Although FIG. 5 indicates an in-ear earphone configuration, it shall be understood and appreciated that an on-ear or an over-the-ear earphone can form an acoustic seal with a user's outer ear or a region of the head adjacent the ear, occluding the user's ear canal 52. The earphone 40 has an acoustic driver 45 positioned in the housing 41 and acoustically coupled with the acoustic chamber 43. The driver 45 can reciprocate or otherwise move to radiate sound, indicated by the dashed line 45a. A microphone transducer 46 is positioned in the housing 41 and acoustically coupled with the duct 44 defining the acoustic port 37.

Anatomical features within a human ear canal occluded by an earphone can define a side cavity acoustically coupled with a user's auditory anatomy 51. For example, the ear tip 42 can form a side volume or cavity acoustically coupled with a user's ear canal. FIG. 5 schematically illustrates such a side cavity 53 positioned between the user-contact surface 42 and a wall of the user's auditory anatomy, e.g., a wall of the ear canal. The side cavity 53 is acoustically coupled with an acoustic chamber 54 defined by the user's auditory anatomy 51, e.g., a wall of the ear canal and other anatomy. As with a side-branch resonator acoustically coupled with an acoustic chamber, the anatomical side cavity 53 can resonate at a natural frequency and absorb acoustic energy from the anatomical chamber 54, particularly when the chamber 54, e.g., the ear canal 52 (e.g., ear canal 21 in FIG. 2), is occluded by an earphone. A similar phenomenon can occur in speech production when generating nasal sounds. In nasal sound production, the oral cavity may be closed at the lips and the nasal cavity remains open at the nostrils. Broad-spectrum waves generated by the vocal cords excite both the oral cavity, which acts as a side cavity with a certain natural frequency or anti-resonance frequency for speech, and also the nasal cavity which emits the nasal sounds at the nostrils.

Additionally, standing waves in a closed ear cavity 54 can generate nulls (nodes) at both ends of the ear canal 52, including adjacent the earphone 40, e.g., adjacent the microphone 46. Given that an earphone inserted in the ear canal shortens the ear canal to less than a typically assumed length of 25 mm, standing waves can occur within a band of frequencies below the typical upper threshold of human hearing, e.g., 20 kHz. Thus, anti-resonance frequencies observed in ear canals occluded by earphones across a sample population of users occurred between about 9 kHz and about 12 kHz. Such frequencies can correspond to an occluded ear canal having a length between about 19 mm and about 14 mm, respectively. The microphone 46 can observe effects of such standing waves as a null or otherwise low-level acoustic response at a so-called anti-resonance frequency. Despite these notches also indicating that the earbud is inserted in the ear canal, their use for detecting the state of the insertion may be less desirable than notches occurring above an audible threshold. For example, generating (and observing) anti-resonance within an audible frequency band typically could require excitation within the audible frequency band of human hearing, which could degrade a perceived sound quality and a corresponding user experience.

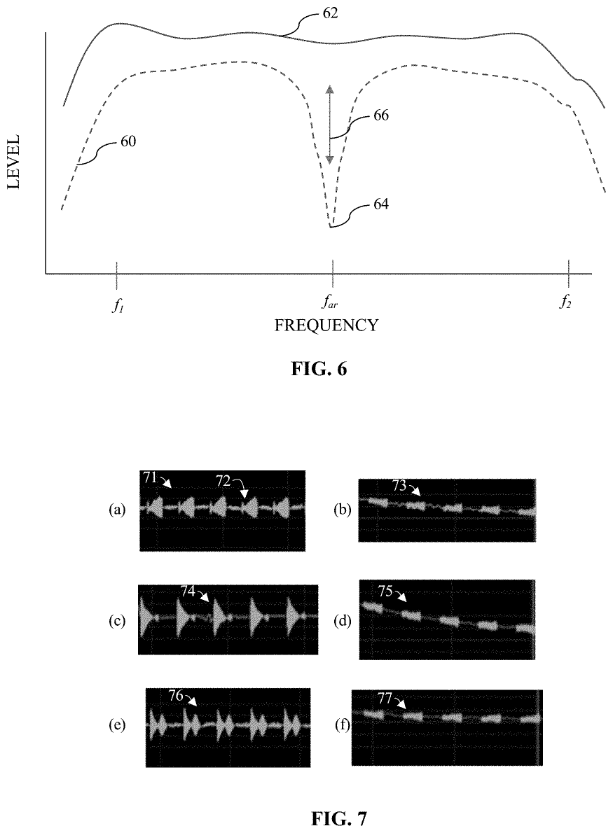

FIG. 6 shows a representative amplitude profile 60 generated by an ear canal occluded by an earphone when excited by an equal-energy acoustic input across frequencies between f₁ and f₂, as observed by a microphone in an earphone, e.g., the microphone 46. In FIG. 6, the response 60 is typical of a response observed by an earphone microphone 46 when an ear canal is occluded and excited, or driven, by an acoustic radiator, e.g., driver 45. As shown in FIG. 6, the response 60 exhibits a low-level trough 64 concentrated at a particular frequency, e.g., an anti-resonance frequency, fₐᵣ, within the band spanning from a lower threshold frequency, f₁, to an upper threshold frequency, f₂. Although the level of the trough 64 may be non-zero, it is substantially lower than the level at an adjacent frequency, as depicted by the arrow 66. Unlike when the earphone is inserted in the ear canal which displays a trough 64, when the earphone is not inserted in a human ear canal the frequency response of the microphone 46 corresponding to the same equal energy acoustic input is mainly flat between the f₁ and f₂, as depicted by response 62.

FIG. 7 depicts several amplitude profiles corresponding to frequency sweeps from about 20 kHz to about 24 kHz observed by a working embodiment of an earphone under different conditions. Amplitude Profile (a) in FIG. 7 was observed when an in-ear earphone donned by a first user repetitively emitted a sound with varying frequencies across a selected frequency range from f₁ to f₂, e.g., by adjusting a frequency of the output within a selected frequency band extending from a first threshold frequency to a second threshold frequency to determine a frequency response within the selected frequency band. In FIG. 7, the Amplitude Profile (a), which represents a frequency response of an occluded ear canal, has five groups of observed amplitude profile 71 similar to the amplitude profile 60 in FIG. 6. Each observed amplitude profile 71 consistently shows an anti-resonance trough 72 and corresponds to a single sweep across the spectral envelope. By contrast, Amplitude Profile (b) in FIG. 7 was observed when the first user doffed the earphone used to generate Response (a). Like Amplitude Profile (a), Amplitude Profile (b) was observed when the doffed earphone emitted sound across the selected frequency range, resulting in the several groups of observed amplitude profile 73 corresponding to the amplitude profile 62 of FIG. 6. However, contrary to each profile 71 in Amplitude Profile (a), each observed amplitude profile 73 consistently lacks an anti-resonance trough 72.

Similarly, Amplitude Profile (c) was observed when a second user donned an earphone and Amplitude Profile (d) was observed when the second user doffed the earphone. And, Amplitude Profiles (e) and (f) were observed when a third user respectively donned and doffed an earphone. Similar to each amplitude profile 71 in Amplitude Profile (a), each amplitude profile 74, 76 in Amplitude Profile (c) and Amplitude Profile (e), respectively, exhibits a corresponding anti-resonance trough, albeit at a frequency corresponding to each user's unique auditory anatomy. And, similar to each amplitude profile 73 in Amplitude Profile (b), each amplitude profile 75, 77 in Amplitude Profile (d) and Amplitude Profile (f), respectively, lacks a corresponding anti-resonance trough.

Consequently, by listening for anti-resonance, e.g., a trough, in the frequency response of an earphone's surroundings, an earphone can discern whether the earphone occludes a user's ear canal. Consequently, observations of sound indicating a presence of an anti-resonance trough within a selected spectral envelope can indicate that the earphone has been donned by a user in a manner that occludes the user's ear canal.

Referring again to FIG. 4, the earphone 40 also has a processing component 47 configured to detect anti-resonance within a spectral envelope observed by the microphone transducer 46. For instance, the processing component 47 can assess sound observed by the microphone 46 within a frequency band having a lower threshold of about 20 kHz and an upper threshold of about 24 kHz. Based on the sound assessment, the processing component can determine when the earphone 40 is donned by a user, as by detecting a frequency at which anti-resonance occurs or by detecting another characteristic indicative of a presence of anti-resonance.

Such assessment can proceed according to a classification system using Gaussian Mixture Models (GMM) trained using observations of spectral envelopes as presented in FIG. 6 and FIG. 7. For example, the shape of each observed spectral envelope shown in FIG. 7 can be modeled using a polynomial function of order 3, 4, or 5, though higher-order models also are possible. Because anti-resonance occurs only when the earphone has been donned by a user, each group of polynomial coefficients modeling a donned state (e.g., Amplitude Profiles (a), (c), and (e)) differ significantly from the coefficients modeling a doffed state (e.g., Amplitude Profiles (b), (d), and (f)). Accordingly, and despite differences among the frequency responses generated when an earphone is donned by different users, e.g., differences among frequency responses 71, 74 and 76, a GMM-based classification system can yield high rates of accuracy when trained with observed frequency responses from a sufficiently large population. For example, a GMM-based classifier trained using order 5 and order 6 polynomial coefficients to model frequency responses within a spectral envelope between about 20 kHz and about 24 kHz on over twenty users who donned and doffed earphones yielded a 94% accuracy of true positives and about 10% for false positives. Other classification methods can alternatively be employed for detecting the state of the earphone with regards to insertion into a human ear.

Nonetheless, anti-resonance frequencies for some users (and for some earphone configurations) occur below and above the about 20 kHz to about 24 kHz frequency range. Consequently, accuracy may be improved by extending the range of the spectral envelope used to define the frequency range of emitted sound, as well as by increasing the size of the user population used to train the classification system. In an embodiment, anti-resonance occurred within one or more relatively narrow bandwidths across audible and inaudible frequencies, e.g., between about 0 Hz and about 24 kHz. For example, antiresonance occurred between about 5 kHz and about 8 kHz, such as, for example, between about 5.5 kHz and about 7.5 kHz, e.g., between about 6 kHz and about 7 kHz. Antiresonance also occurred for the same embodiment between about 13 kHz and about 14.5 kHz, such as, for example, between about 12 kHz and about 15 kHz, e.g., between about 13.5 kHz and about 14 kHz. Antiresonance also occurred for the same embodiment between about 16 kHz and about 18 kHz, such as, for example, between about 16.5 kHz and about 17.5 kHz, e.g., between about 16.7 kHz and about 17 kHz. Antiresonance also occurred for the same embodiment between about 19 kHz and about 20.5 kHz, such as, for example, between about 18.5 kHz and about 21 kHz, e.g., between about 19.2 kHz and about 20 kHz.

FIG. 8 shows a schematic illustration of anti-resonances 82 on a typical spectrogram showing an output signal of an error microphone when an earphone is introduced to a user's ear. Sections 81a, 81b correspond to time before an earphone was introduced in the user's ear and after the earphone was extracted, respectively. Section 83 corresponds to time the earphone remained inserted in the user's ear canal. In FIG. 8, a region of relatively lower energy is shown as a curved line. Antiresonances can occur at more than one frequency when an earphone is inserted in a user's ear. FIG. 8 shows antiresonance by way of example occurring within a particular frequency region of interest, between f₁ and f₂. For example, plural regions of anti-resonance may appear when full-band white noise (e.g., between about 0 Hz to about 24 kHz) is emitted by the earphone when inserted into a user's ear.

Although a binary state model (e.g., “worn” or “not worn”) has just been described, it is possible to include other, e.g., intermediate, states. For example, antiresonance frequencies may shift over time, e.g., as a user pushes an earbud into the user's ear canal. Antiresonance may appear at one frequency and as the earbud extends farther into the user's ear, the frequency can shift upward. Accordingly, antiresonance at selected frequencies can be used to discern not only whether the earbud is being worn or not worn, but also can be used to assess a measure of “fit” to a given wearer, or a measure of how well the earbud has been inserted.

A GMM-based classifier as described above can be trained using frequency responses (or corresponding polynomial coefficients) derived across more than two states, e.g., three or more states. For example, a frequency response can be observed for each of three or more states for each in a sample population of users. As an example, the contemplated states can be donned (or worn properly), doffed (or not worn), and poorly fitting (or worn improperly). For a “poorly fitting” state, an in-ear earphone may not be inserted into the user's ear canal properly or entirely, allowing a measure of acoustic leakage past the user-contact surface. Alternatively, an over-the-ear earphone may be placed partially “on” a user's ear, such that the earphone cushion allows some acoustic leakage through a gap between the cushion and the user's head. In any event, a GMM-based classification system can be trained using the frequency responses (or corresponding polynomial coefficients) observed during the donned (or worn properly), doffed (or not worn), and poorly fitting (or worn improperly) states.

Referring now to FIG. 9, a method 90 for operating an audio device (e.g., a media device or an audio accessory as in FIG. 1) in correspondence with a detected state of the earphone is described. At block 91, an acoustic driver radiates sound across a range of frequencies (the spectral envelope). For example, the driver can radiate sound at selected frequencies ranging from about 20 kHz to about 24 kHz, such as, for example, between about 18 kHz and about 26 kHz, e.g., between about 19 kHz and about 25 kHz. Of course, the driver can radiate sound at selected freqeuncies between one or more other relatively narrow bandwidths across audible and inaudible frequencies, e.g., in addition to or alternative to the range between about 20 kHz and about 24 kHz. Examples of alternative bandwidths include, for example, between about 5 kHz and about 8 kHz, between about 13 kHz and about 14.5 kHz, between about 16 kHz and about 18 kHz, and between about 19 kHz and about 20.5 kHz. Alternative bandwidths can have an upper threshold about 24 kHz, e.g., at 30 kHz, 36 kHz, or 48 kHz, and antiresonance can be observed in these higher bandwidths. As a practical matter, the upper threshold is limited by the sampling frequency, e.g., the upper threshold is about one-half the highest sampling frequency to comply with Nyquist's theorem.

At block 92, a microphone in the earphone, e.g., microphone 46, observes a frequency response of the earphone's surroundings across the spectral envelope. At block 93, the frequency response is assessed. For example, a presence or an absence of anti-resonance can be determined. Alternatively, coefficients for a polynomial model of the spectral envelope can be determined.

Further, at block 94, a state of the earphone can be classified (e.g., as either being worn or being not worn). For example, the classification can proceed based on a determination that anti-resonance is present. Alternatively, coefficients for a polynomial model of the spectral envelope can be entered into a GMM-based classifier trained as described above which will detect the state of the earphone.

And, at block 95, operation of the audio device can be affected according to the classified state of the earphone. For example, an earphone classified as being “not worn” can power down and/or emit a control signal to a corresponding media device, e.g., to cause the media device to power down. Similarly an earphone classified as being “worn” can power up the microphone and necessary circuitry for monitoring the user's speech.

In another aspect, some audio accessories have interchangeable or replaceable user-interface components that provide a measure of customized fit for users. As an example, an in-ear earphone can be accompanied by a kit of interchangeable ear-tips. Each ear-tip in the kit can have a unique combination of size, shape and stiffness, for example. Such a kit allows a user to select the ear-tip that provides the “best” fit, e.g., combination of comfort and sound quality. Accordingly, if at block 84 the earphone is classified as having a poor fit or otherwise being improperly or insufficiently fitting with a user, the earphone can emit an output signal to prompt the user to use a different ear-tip. For example, the earphone can emit an audible tone or other user-perceptible output to prompt the user to act. Alternatively, the earphone can transmit a control signal to the corresponding media device and, responsive to the control signal, the media device can prompt the user to act. For example, the media device can produce a visible prompt on a screen or can transmit an audio signal (e.g., containing speech) to the earphone to prompt the user to act, as by changing ear-tips.

### VII. Computing Environments

FIG. 10 shows an example of a suitable architecture for an audio appliance (e.g., a media device 10 or an accessory device described above in relation to FIG. 1). The audio appliance 100 includes an audio acquisition module 101 and aspects of a computing environment (e.g., described more fully below in connection with FIG. 11) that can cause the appliance to communicate with another device in a defined manner. For example, the illustrated appliance 100 includes a processing unit 104 and a memory 105 that contains instructions the processing unit can execute to cause the audio appliance to carry out a defined task. For example, the task can pertain to speech recognition or the task can pertain to one or more aspects of listening for anti-resonance or otherwise determining a state of an earphone.

For example, such instructions can cause the audio appliance 100 to capture ambient sound with the audio acquisition module 101. The captured sound may be a frequency response to sound emitted across a spectral envelope. The instructions can further cause the audio appliance to assess the frequency response and to determine a state of the earphone based on the assessment.

Referring still to FIG. 10, an audio appliance typically includes a microphone transducer to convert incident acoustic signals to corresponding electrical output. As used herein, the terms “microphone” and “microphone transducer” are used interchangeably and mean an acoustic-to-electric transducer or sensor that converts an incident acoustic signal, or sound, into a corresponding electrical signal representative of the incident acoustic signal. Typically, the electrical signal output by the microphone is an analog signal.

Although a single microphone is depicted in FIG. 10, this disclosure contemplates the use of plural microphones. For example, plural microphones can be used to obtain plural distinct acoustic signals emanating from a given acoustic scene, and the plural versions can be processed independently and/or combined with one or more other versions before further processing by the audio appliance 100.

As shown in FIG. 10, the audio acquisition module 101 can include a microphone transducer 102 and a signal conditioner 103 to filter or otherwise condition the acquired representation of ambient sound. Some audio appliances have an analog microphone transducer and a pre-amplifier to condition the signal from the microphone.

As shown in FIG. 10, an audio appliance 100 or other electronic device can include, in its most basic form, a processor 104, a memory 105, and a loudspeaker or other electro-acoustic transducer 107, and associated circuitry (e.g., a signal bus, which is omitted from FIG. 10 for clarity).

The audio appliance 100 schematically illustrated in FIG. 10 also includes a communication connection 106, as to establish communication with another computing environment or an audio accessory, such as accessory 18a, 18b (FIG. 1). The memory 105 can store instructions that, when executed by the processor 104, cause the circuitry in the audio appliance 100 to drive the electro-acoustic transducer 107 to emit sound over a selected frequency bandwidth or to communicate an audio signal over the communication connection 106 to an audio accessory 18a, 18b for playback. In addition, the memory 105 can store other instructions that, when executed by the processor, cause the audio appliance 100 to perform any of a variety of tasks akin to a general computing environment as described more fully below in connection with FIG. 11.

FIG. 11 illustrates a generalized example of a suitable computing environment 110 in which described methods, embodiments, techniques, and technologies relating, for example, to assessing a local environment for the computing environment or an accessory thereto can be implemented. The computing environment 110 is not intended to suggest any limitation as to scope of use or functionality of the technologies disclosed herein, as each technology may be implemented in diverse general-purpose or special-purpose computing environments, including within an audio appliance. For example, each disclosed technology may be implemented with other computer system configurations, including wearable and/or handheld appliances (e.g., a mobile-communications device, such as, for example, IPHONE®/IPAD®/AIRPODS®/HOMEPOD™ devices, available from Apple Inc. of Cupertino, Calif.), multiprocessor systems, microprocessor-based or programmable consumer electronics, embedded platforms, network computers, minicomputers, mainframe computers, smartphones, tablet computers, data centers, audio appliances, and the like. Each disclosed technology may also be practiced in distributed computing environments where tasks are performed by remote processing devices that are linked through a communications connection or network. In a distributed computing environment, program modules may be located in both local and remote memory storage devices.

The computing environment 110 includes at least one central processing unit 111 and a memory 112. In FIG. 11, this most basic configuration 113 is included within a dashed line. The central processing unit 111 executes computer-executable instructions and may be a real or a virtual processor. In a multi-processing system, or in a multi-core central processing unit, multiple processing units execute computer-executable instructions (e.g., threads) to increase processing speed and as such, multiple processors can run simultaneously, despite the processing unit 111 being represented by a single functional block.

A processing unit, or processor, can include an application specific integrated circuit (ASIC), a general-purpose microprocessor, a field-programmable gate array (FPGA), a digital signal controller, or a set of hardware logic structures (e.g., filters, arithmetic logic units, and dedicated state machines) arranged to process instructions.

The memory 112 may be volatile memory (e.g., registers, cache, RAM), non-volatile memory (e.g., ROM, EEPROM, flash memory, etc.), or some combination of the two. The memory 112 stores instructions for software 118a that can, for example, implement one or more of the technologies described herein, when executed by a processor. Disclosed technologies can be embodied in software, firmware or hardware (e.g., an ASIC).

A computing environment may have additional features. For example, the computing environment 110 includes storage 114, one or more input devices 115, one or more output devices 116, and one or more communication connections 117. An interconnection mechanism (not shown) such as a bus, a controller, or a network, can interconnect the components of the computing environment 110. Typically, operating system software (not shown) provides an operating environment for other software executing in the computing environment 110, and coordinates activities of the components of the computing environment 110.

The store 114 may be removable or non-removable, and can include selected forms of machine-readable media. In general, machine-readable media includes magnetic disks, magnetic tapes or cassettes, non-volatile solid-state memory, CD-ROMs, CD-RWs, DVDs, magnetic tape, optical data storage devices, and carrier waves, or any other machine-readable medium which can be used to store information, and which can be accessed within the computing environment 110. The storage 114 can store instructions for the software 118b that can, for example, implement technologies described herein, when executed by a processor.

The store 114 can also be distributed, e.g., over a network so that software instructions are stored and executed in a distributed fashion. In other embodiments, e.g., in which the store 114, or a portion thereof, is embodied as an arrangement of hardwired logic structures, some (or all) of these operations can be performed by specific hardware components that contain the hardwired logic structures. The store 114 can further be distributed, as between or among machine-readable media and selected arrangements of hardwired logic structures. Processing operations disclosed herein can be performed by any combination of programmed data processing components and hardwired circuit, or logic, components.

The input device(s) 115 may be any one or more of the following: a touch input device, such as a keyboard, keypad, mouse, pen, touchscreen, touch pad, or trackball; a voice input device, such as one or more microphone transducers, speech-recognition technologies and processors, and combinations thereof; a scanning device; or another device, that provides input to the computing environment 110. For audio, the input device(s) 115 may include a microphone or other transducer (e.g., a sound card or similar device that accepts audio input in analog or digital form), or a computer-readable media reader that provides audio samples and/or machine-readable transcriptions thereof to the computing environment 110.

Speech-recognition technologies that serve as an input device can include any of a variety of signal conditioners and controllers, and can be implemented in software, firmware, or hardware. Further, the speech-recognition technologies can be implemented in a plurality of functional modules. The functional modules, in turn, can be implemented within a single computing environment and/or distributed between or among a plurality of networked computing environments. Each such networked computing environment can be in communication with one or more other computing environments implementing a functional module of the speech-recognition technologies by way of a communication connection.

The output device(s) 116 may be any one or more of a display, printer, loudspeaker transducer, DVD-writer, signal transmitter, or another device that provides output from the computing environment 110, e.g., an audio accessory 18a, 18b (FIG. 1). An output device can include or be embodied as a communication connection 117.

The communication connection(s) 117 enable communication over or through a communication medium (e.g., a connecting network) to another computing entity or accessory. A communication connection can include a transmitter and a receiver suitable for communicating over a local area network (LAN), a wide area network (WAN) connection, or both. LAN and WAN connections can be facilitated by a wired connection or a wireless connection. If a LAN or a WAN connection is wireless, the communication connection can include one or more antennas or antenna arrays. The communication medium conveys information such as computer-executable instructions, compressed graphics information, processed signal information (including processed audio signals), or other data in a modulated data signal. Examples of communication media for so-called wired connections include fiber-optic cables and copper wires. Communication media for wireless communications can include electromagnetic radiation within one or more selected frequency bands.

Machine-readable media are any available media that can be accessed within a computing environment 110. By way of example, and not limitation, with the computing environment 110, machine-readable media include memory 112, storage 114, communication media (not shown), and combinations of any of the above. Tangible machine-readable (or computer-readable) media exclude transitory signals.

As explained above, some disclosed principles can be embodied in a store 114. Such a store can include tangible, non-transitory machine-readable medium (such as microelectronic memory) having stored thereon or therein instructions. The instructions can program one or more data processing components (generically referred to here as a “processor”) to perform one or more processing operations described herein, including estimating, computing, calculating, measuring, adjusting, sensing, measuring, filtering, correlating, and decision making, as well as, by way of example, addition, subtraction, inversion, and comparison. In some embodiments, some or all of these operations (of a machine process) can be performed by specific electronic hardware components that contain hardwired logic (e.g., dedicated digital filter blocks). Those operations can alternatively be performed by any combination of programmed data processing components and fixed, or hardwired, circuit components.

### VIII. Other Embodiments

The examples described above generally concern audio accessories configured to classify their state, e.g., relative to a surrounding environment, together with related systems and methods. The previous description is provided to enable a person skilled in the art to make or use the disclosed principles. Embodiments other than those described above in detail are contemplated based on the principles disclosed herein, together with any attendant changes in configurations of the respective apparatus described herein, without departing from the spirit or scope of this disclosure. Various modifications to the examples described herein will be readily apparent to those skilled in the art.

Directions and other relative references (e.g., up, down, top, bottom, left, right, rearward, forward, etc.) may be used to facilitate discussion of the drawings and principles herein, but are not intended to be limiting. For example, certain terms may be used such as “up,” “down,”, “upper,” “lower,” “horizontal,” “vertical,” “left,” “right,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” surface can become a “lower” surface simply by turning the object over. Nevertheless, it is still the same surface and the object remains the same. As used herein, “and/or” means “and” or “or”, as well as “and” and “or.” Moreover, all patent and non-patent literature cited herein is hereby incorporated by reference in its entirety for all purposes.

And, those of ordinary skill in the art will appreciate that the exemplary embodiments disclosed herein can be adapted to various configurations and/or uses without departing from the disclosed principles. Applying the principles disclosed herein, it is possible to provide a wide variety of damped acoustic enclosures, and related methods and systems. For example, the principles described above in connection with any particular example can be combined with the principles described in connection with another example described herein. Thus, all structural and functional equivalents to the features and method acts of the various embodiments described throughout the disclosure that are known or later come to be known to those of ordinary skill in the art are intended to be encompassed by the principles described and the features claimed herein. Accordingly, neither the claims nor this detailed description shall be construed in a limiting sense, and following a review of this disclosure, those of ordinary skill in the art will appreciate the wide variety of proximity sensors, and related methods and systems that can be devised under disclosed and claimed concepts.

Moreover, nothing disclosed herein is intended to be dedicated to the public regardless of whether such disclosure is explicitly recited in the claims. No claim feature is to be construed under the provisions of 35 USC 112(f), unless the feature is expressly recited using the phrase “means for” or “step for”.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The appended claims are not intended to be limited to the embodiments shown herein, but are to be accorded the full scope consistent with the language of the claims, wherein reference to a feature in the singular, such as by use of the article “a” or “an” is not intended to mean “one and only one” unless specifically so stated, but rather “one or more”. Further, in view of the many possible embodiments to which the disclosed principles can be applied, I reserve to the right to claim any and all combinations of features and technologies described herein as understood by a person of ordinary skill in the art, including, for example, all that comes within the scope and spirit of the following claims.

We currently claim:

1. An earphone comprising:
a housing and a corresponding user-contact surface configured to urge against a user's anatomy, wherein the housing defines an acoustic chamber and an acoustic port opening from the acoustic chamber, the user-contact surface configured to form an acoustic seal with the user's anatomy and acoustically couple the acoustic chamber with the user's ear canal when the earphone is donned;
an acoustic driver positioned in the housing and acoustically coupled with the acoustic chamber;
a microphone transducer acoustically coupled with the acoustic port; and
a processing component configured to detect anti-resonance in sound observed by the microphone transducer across a selected spectral envelope below, spanning or above the upper threshold of human hearing.

2. The earphone according to claim 1, wherein the processing component is further configured to classify the earphone as being donned when anti-resonance is detected.

3. The earphone according to claim 2, wherein the processing component is further configured to classify a quality of the acoustic seal between the user-contact surface and the user's anatomy based at least in part on the frequency response across the spectral envelope.

4. The earphone according to claim 1, wherein the processing component is further configured to affect operation of the earphone responsive to detection of anti-resonance in the spectral envelope.

5. The earphone according to claim 1, wherein the processing component is further configured to cause the acoustic driver to emit sound in the spectral envelope and to cause the microphone transducer to observe sound in the spectral envelope.

6. The earphone according to claim 1, wherein the spectral envelope has a lower frequency threshold of about 20 kHz and an upper frequency threshold of about 24 kHz.

7. The earphone according to claim 1, wherein the processing component is further configured to assess a frequency response across the spectral envelope and to identify a presence of a notch in the frequency response.

8. The earphone according to claim 1, further comprising an ear-tip defining the user-contact surface, wherein the user's anatomy comprises an inner surface of the user's ear canal, wherein the user-contact surface is configured to urge against the inner surface of the wearer's ear canal and form the acoustic seal.

9. An earphone comprising a housing, a loudspeaker transducer and a microphone transducer positioned in the housing, a processor, and a memory, wherein the memory contains instructions that, when executed by the processor, cause the earphone:
to assess sound observed by the microphone within a frequency band having a lower threshold of about 20 kHz and an upper threshold of about 24 kHz; and
based on the sound assessment, to determine when the earphone is donned by a user.

10. The earphone according to claim 9, wherein the assessment of sound comprises an assessment of a frequency response within the frequency band.

11. The earphone according to claim 10, wherein the instructions, when executed by the processor, further cause the earphone to identify a presence or an absence of anti-resonance within the frequency band from the assessment of the frequency response.

12. The earphone according to claim 10, wherein the instructions, when executed by the processor, further cause the earphone to classify a quality of fit between the earphone and a corresponding region of a user's anatomy.

13. The earphone according to claim 9, further comprising an in-ear ear-tip defining a corresponding user-contact surface configured to urge against a wall of a user's ear canal and form an acoustic seal between the in-ear ear-tip and the user's ear canal.

14. The earphone according to claim 13, wherein the housing defines an acoustic chamber and the in-ear ear-tip defines an acoustic port opening from the acoustic chamber, wherein the acoustic port is configured to acoustically couple the acoustic chamber with the user's ear canal when the in-ear ear-tip is inserted into the user's ear canal.

15. The earphone according to claim 14, wherein the instructions, when executed by the processor, further cause the earphone to classify a quality of the acoustic seal between the in-ear ear-tip and the user's ear canal.

16. A method for controlling operation of an earphone, wherein the earphone houses a microphone transducer and an acoustic driver, the method comprising:
emitting sound across a spectral envelope with the acoustic driver;
assessing sound observed by the microphone within the spectral envelope, wherein the spectral envelope has a lower threshold of about 20 kHz and an upper threshold of about 24 kHz; and
based on the sound assessment, determining when the earphone is donned by a user.

17. The method according to claim 16, wherein the act of assessing sound within the spectral envelope comprises determining a presence or an absence of anti-resonance within the spectral envelope.

18. The method according to claim 17, further comprising classifying a quality of fit between the earphone and a user's anatomy based on the sound assessment.

19. The method according to claim 16, affecting operation of the earphone responsive to detection of anti-resonance in the spectral envelope.

20. The method according to claim 16, wherein the act of assessing sound within the spectral envelope comprises assessing a frequency response across the spectral envelope.
